(19) United States
(12) Patent Application Publication
(10) Pub. No.: US 2004/0128020 A1
(43) Pub. Date: Jul. 1, 2004

(54) Control device and control system for a plastics processing machine

(75) Inventor: Gunther Fischbach, Furstenfeldbruck (DE)

Correspondence Address: Ursula B. Day, Suite 4714, 350 Fifth Avenue, New York, NY, 10118, US

(73) Assignee: Mannesmann Plastics Machinery GmbH, Munchen (DE)

(21) Appl. No.: 10/669,086

(22) Filed: Sep. 23, 2003

(30) Foreign Application Priority Data
Sep. 26, 2002 (DE) 102 44 836.1-51

(51) Int. Cl. B29C 45/00

(52) U.S. Cl. 700/200; 425/162

(57) ABSTRACT

A plastics processing machine can be operated more flexibly by providing the controller of the plastic-processing machine with a wireless communication device that can exchange status and operating information with a remote input/output device via a communication network. The remote input/output device can be, for example, a mobile telephone or a handheld computer with integrated wireless capabilities.

### CROSS-REFERENCES TO RELATED APPLICATIONS

This application claims the priority of German Patent Application, Serial No. 102 44 836.1-51, filed Sep. 26, 2002, pursuant to 35 U.S.C. 119(a)-(d), the disclosure of which is incorporated herein by reference.

### BACKGROUND OF THE INVENTION

The present invention relates to a control device and a control system for a plastics processing machine, and more particular to a control device and control system with a wireless interface for exchanging information between machine components and external input/output devices.

Control commands and/or various parameters of a plastics processing machine have to be entered during maintenance and/or during operation of the plastics processing machine, in particular of an injection molding machine. This is conventionally done by using input devices which are either directly attached to the control device of the machine or connected to the control device by a cable. This poses a problem in that an operator of the plastics processing machine is not free to move around and to work unconstrained. Instead, to operate the plastics processing machine, the operator must remain in front of the control device or at least within a radius of the wired connection.

It would therefore be desirable and advantageous to provide an improved control device and a control system for machines, in particular for plastics processing machines, which obviates prior art shortcomings and is able to specifically make the machine control more flexible

### SUMMARY OF THE INVENTION

According to one aspect of the present invention, a control device for a plastics processing machine, in particular for an injection molding machine, having machine components to be controlled, includes a controller operatively coupled to the machine components, at least one machine interface adapted to communicate operating signals and status signals between the controller and the machine components, stationary controls for displaying status signals and for entering operating signals, and a communication device adapted to exchange via a wireless communication network operating information and status information between the controller and a remote input/output device. The status signals and operating signals are transmitted via a wireless communication network. The communication network can be any available network, such as a mobile telephone network. Dedicated and proprietary networks can also be used.

According to another aspect of the invention, a control system for a plastics processing machine, in particular for an injection molding machine, includes a remote data input/output device and a controller for controlling machine components of the machine, as described above. The status and operating signals are transmitted between the remote data input/output device and the communication device via a wireless communication network.

Status information, such as operating data, warning signals and/or error messages, can be easily transmitted from the controller via the communication network to a remote input/output device, while corresponding operating commands/signals can be transmitted from the input/output device via the communication network to the controller. The input/output device can be implemented through conventional hardware, for example a mobile telephone, a portable computer as well as a PDA (e.g., a handheld computer, preferably with integrated wireless network capabilities). The use of conventional hardware obviates the need for application-specific components, making the installation and operation inexpensive.

The wireless communication device preferably includes a device for speech recognition, thereby enabling operation via voice commands. In particular, the installer or operator of the machine can advantageously use, for example, a headset or the like of a mobile telephone as a input/output device and work hands free while at the same time communicating with the controller of the plastics processing machine. The communication device can advantageous also include a speech generator, thus enabling a voice dialog without the need to type in data.

Preferably, the communication device uses conventional data protocols, so that the data can be exchanged with the input/output device, for example, in the form of electronic short messages (SMS, e-mail). By assigning proprietary identifiers (“telephone numbers”), a single input/output device can be used to monitor and operate several plastics processing machines. Alternatively, a plastics processing machine can communicate with several input/output devices.

### BRIEF DESCRIPTION OF THE DRAWING

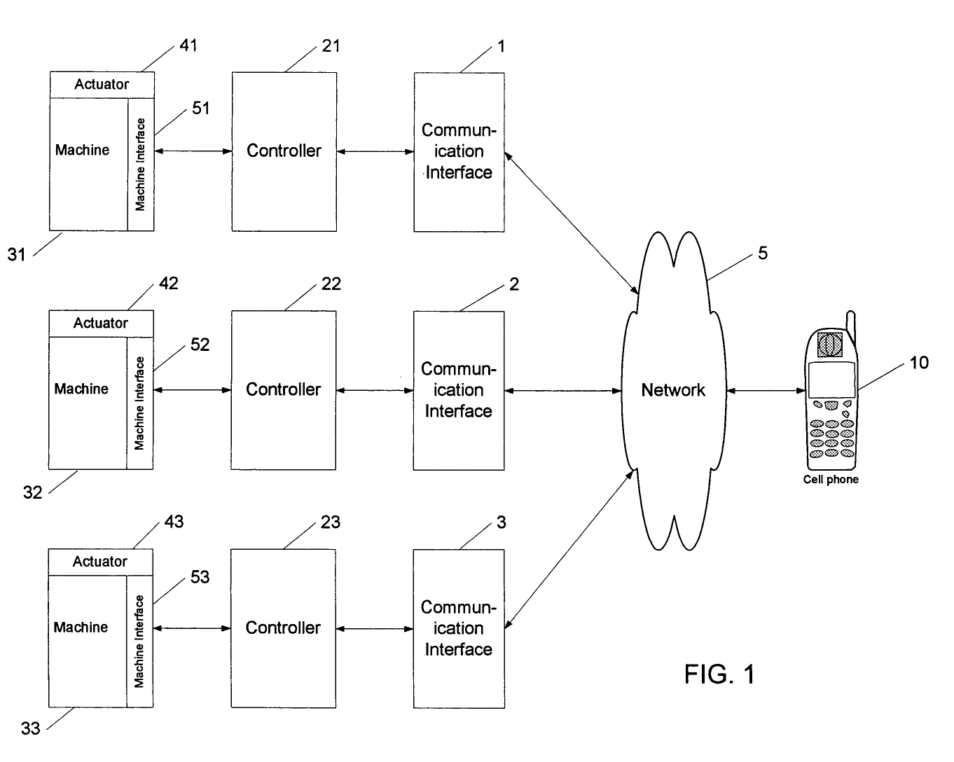

Other features and advantages of the present invention will be more readily apparent upon reading the following description of currently preferred exemplified embodiments of the invention with reference to the accompanying drawing, in which the sole FIG. 1 depicts schematically a wireless communication system between a machine controller and a input/output device in accordance with the present invention.

### DETAILED DESCRIPTION OF PREFERRED EMBODIMENTS

The depicted embodiment is to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

Turning now to FIG. 1, there are shown several controllers 21, 22, 23 of plastics processing machines 31, 32, 33. Each of the controllers 21, 22, 23 is connected with a corresponding communication device 1, 2, 3 which in turn communicates via a communication network 5, for example a standard wireless (cellular) network, with a remote input/output device 10, which in the present example is shown as a conventional mobile telephone 10.

For example, one of the controllers 21, 22, 23 receives from the associated plastics processing machine 31, 32, 33 a status signal, such as sensor signals etc., and supplies according to a control program operating signals, such as actuator signals, etc., to machine components, such as actuators 41, 42, 43 of the corresponding machine 31, 32, 33. Command signals can be entered through stationary controls (not shown) located, for example, on the controller 21, 22, 23, and status signals, such as sensor signals or alarm signals can be displayed on a display (not shown). An exemplary controller 21 is also in data communication with a corresponding communication device 1, which represents a communication interface between the controller 21 and the communication network 5. Details of the communication network 5 are not shown; as mentioned above, the communication network 5 can be, for example, a conventional telephone network configured from elements of a wired network, one or more wireless networks, such as cellular networks, or a mixture thereof.

Selected status information, such as alarm signals and the like, or selectable status information can be transmitted via a communication device 1, 2, 3 to the input/output device 10, for example the mobile telephone 10, where there can be displayed, for example as electronic short messages or in acoustic form. The communication device 1, 2, 3 can include a speech generator, so that information and commands can be transmitted via voice prompts.

On the other hand, operating information can be transmitted via controls on the input/output device 10, i.e., the buttons of the mobile telephone 10, or via a voice input to one or more of the communication devices 1, 2, 3, which then transmit the operating information as operating signals to the corresponding controllers 21, 22, 23, where the operating signals are converted into corresponding signals for operating the machine components.

To avoid competing control commands, i.e., commands entered concurrently via the stationary controls as well as by the input/output device 10, a hierarchy can be provided so that in the event of a conflict the commands entered via the stationary operating elements receive priority.

According to the invention, an installer or operator of a plastics processing machine can enter data into the machine remotely, via a wireless connection and optimally hands free and if necessary by speech commands using conventional input/output devices. Data can also be received from the machine and displayed. It is also possible to use the Internet protocol and/or PDAs with integrated wireless communication capabilities for controlling the machine.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. A control device for a plastics processing machine, in particular for an injection molding machine, having machine components to be controlled, comprising:
a controller operatively coupled to the machine components;
at least one machine interface adapted to communicate operating signals and status signals between the controller and the machine components;
stationary controls for displaying status signals and for entering operating signals, and
a communication device adapted to exchange via a wireless communication network operating information and status information between the controller and a remote input/output device.

2. The control device of claim 1, wherein the communication device is formed as an interface between the controller and the wireless communication network and converts the status signals into the status information having a data format compatible with the wireless communication network, and the operating information having a data format compatible with the wireless communication network into the operating signals.

3. The control device of claim 1, wherein the communication device includes a device for speech recognition.

4. The control device of claim 1, wherein the communication device includes a device for speech generation.

5. The control device of claim 1, wherein the communication device transmits and receives the status and operating information in an Internet-compatible protocol.

6. A control system for a plastics processing machine, in particular for an injection molding machine, having machine components to be controlled, comprising:
a remote data input/output device;
a controller operatively coupled to the machine components;
at least one machine interface adapted to communicate operating signals and status signals between the controller and the machine components;
stationary controls for displaying status signals and for entering operating signals, and
a communication device adapted to exchange via a wireless communication network operating information and status information between the controller and the input/output device.

7. The control system of claim 6, wherein the input/output device is selected from the group consisting of a mobile telephone, a handheld computer and an electronic terminal.

8. The control system of claim 7, wherein the mobile telephone and one of the handheld computer and the electronic terminal are combined into a single unit.

9. A plastics processing machine, in particular for an injection molding machine, having machine components to be controlled, comprising:
a controller operatively coupled to the machine components;
at least one machine interface adapted to communicate operating signals and status signals between the controller and the machine components;
stationary controls for displaying status signals and for entering operating signals, and
a communication device adapted to exchange via a wireless communication network operating information and status information between the controller and a remote input/output device.

10. The plastics processing machine of claim 10, wherein the status and operating signals are transmitted between the remote data input/output device and the communication device via the wireless communication network.
